(19) United States
(12) Patent Application Publication
(10) Pub. No.: US 2002/0093596 A1
(43) Pub. Date: Jul. 18, 2002

(54) Video amplifier circuits for multi-output distribution of video signals

(76) Inventor: William J. Grasty JR., Chapel Hill, NC (US)

Correspondence Address: Don Witmer, Chairman and Chief Executive Officer Home Director, C/O Digital Interiors Inc, 7132 Santa Teresa BLvd, San Jose, CA, 95139, US

(21) Appl. No.: 09/764,544

(22) Filed: Jan. 18, 2001

(51) Int. Cl. H04N 7/173

(52) U.S. Cl. 348/707

(57) ABSTRACT

Video amplifier circuits and cable/video distribution modules including video amplifier circuits are provided. The video amplifier circuits include a first stage amplifier having a high signal gain and a low noise figure and having an input coupled to a video input signal and an output. A second stage amplifier having a high output power and a low distortion has an input electrically coupled to the output of the first stage amplifier and an output. A splitter circuit has an input coupled to the output of the second stage amplifier and a plurality of outputs.

### FIELD OF THE INVENTION

The present invention relates generally to video signal communications, and more particularly to distribution of video signals.

### BACKGROUND OF THE INVENTION

Increasingly, existing homes and homes under construction are being “networked” wherein communications cables (video, data, and/or telecommunications cables) are being extended to many rooms and, in some cases, to multiple locations within each room. The benefits of “home networking” may include the ability to network multiple computers, printers and peripherals throughout a home and to access the Internet through a single high-speed connection; to watch an internally modulated video signal such as a video cassette recorder (VCR), digital video disk (DVD), or satellite television receiver from any room in the home; to use a digital phone system, such as an ISDN line, throughout the home; to add security video cameras in the home and view them on any television; and to add future equipment that may allow a homeowner to use the same hand-held remote control in any room.

Home networking typically requires the use of a central distribution panel which serves as a gateway or interface to various communications services. Within these central distribution panels, cable distribution modules are typically utilized to receive a cable from a service provider and distribute the service provided among various communications cables that are routed throughout the home. For example, a video cable distribution module may be configured to receive a cable television signal from a cable television service provider and distribute the signal to multiple cables routed within a home. Cable distribution modules may be amplified or non-amplified to divide signals to multiple communications cables, depending upon the number of communications cables involved.

An exemplary central distribution panel 10 with a plurality of video/cable distribution modules 11a, 11b, 11c is illustrated in FIG. 1. With the exception of electric power, communications services entering a home are typically routed into the central distribution panel 10. From the central distribution panel 10, distribution cables and, consequently, the services they provide, are routed to wall taps in various locations throughout a home. Conventionally, the service provided at a particular wall tap is determined by the cable's connection in the central distribution panel 10. For example, if a wall tap is connected to a computer networking hub, a computer networking service is provided at the wall tap. By moving the connection in the central distribution panel 10 from the computer networking hub to a telecommunications module, the service at the wall tap may be changed to telephone service.

One challenge with providing such a flexible distribution approach to video signals is the potential signal degradation caused by splitting video signals such as cable television (CATV) signals. For a typical CATV system, splitting a source signal out to more than four output signals may result in unacceptable signal degradation when using a splitter without amplification. Home distribution systems, such as those described above, are known to provide dual stage video amplifier circuits allowing up to 16 way splitting while still providing an acceptable signal quality. An even greater number of outputs from a signal input can be provided with available single stage high power video amplifiers, such as an ACA0861C available from Anadigics of Warren, N.J. However, such circuitry is typically cost prohibitive for the home distribution environment.

### SUMMARY OF THE INVENTION

Embodiments of the present invention provide video amplifier circuits. The video amplifier circuits include a first stage amplifier having a high signal gain and a low noise figure and having an input coupled to a video input signal and an output. A second stage amplifier having a high output power and a low distortion has an input electrically coupled to the output of the first stage amplifier and an output. A splitter circuit has an input coupled to the output of the second stage amplifier and a plurality of outputs. In various embodiments, the output power of the second stage amplifier is greater than 23 decibels millivolts (dBmV) into 75 ohms and the distortion of the second stage amplifier is Composite Triple Beat (CTB) 56 decibels below carrier (dBc) and/or Composite Second Order (CSO) 58 dBc. The signal gain of the first stage amplifier may be greater than 15 decibels (dB) and the noise figure of the first stage amplifier may be less than 3.5 dB and further may be less than 1.5 dB. The first stage amplifier may be an RF2320 amplifier and the second stage amplifier may be an RF2317 amplifier and the splitter circuit may include more than 16 outputs and even 32 or more outputs.

In other embodiments of the present invention, a first matching circuit couples the video input to the input of the first stage amplifier. A second matching circuit couples the output of the first stage amplifier to the input of the second stage amplifier. A first biasing circuit is electrically coupled to the output of the first stage amplifier and a second biasing circuit is electrically coupled to the output of the second stage amplifier. A direct current (DC) blocking circuit couples the output of the second stage amplifier to the input of the splitter circuit.

In further embodiments of the present invention, the video input signal is a video input/output signal for bidirectional communications and the video amplifier circuit further includes a diplexer circuit having an input electrically coupled to the video input/output signal and a high frequency output electrically coupled to the input of the first stage amplifier and a low frequency connector. A return channel amplifier circuit is electrically coupled between the low frequency connector of the diplexer and the input of the splitter circuit. A combiner circuit couples the return channel amplifier and the second stage amplifier to the input of the splitter circuit. The bi-directional communications may be digital over cable systems interface specification (DOCSIS) protocol communications. The video amplifier circuit may also include a first return channel matching circuit coupling the return channel amplifier to the combiner circuit and a second return channel matching circuit coupling the return channel amplifier to the diplexer circuit.

In other embodiments of the present invention, cable distribution modules are provided for routing a DOCSIS compatible connection with a cable network to a plurality of connection points. The module includes a cable input configured to be connected to the cable network. A diplexer circuit is electrically coupled to the cable input and splits a signal on the cable input into a forward and a return channel. A return channel amplifier circuit is electrically coupled between the plurality of connection points and the diplexer circuit on the return channel. A two stage amplifier circuit is electrically coupled between the diplexer circuit and the plurality of connection points on the forward channel. The two stage amplifier circuit includes a first stage amplifier having a high signal gain and a low noise figure and a second stage amplifier having a high output power and a low distortion. A combiner circuit couples the return channel amplifier circuit and the two stage amplifier circuit to the plurality of connection points. A splitter circuit couples the combiner circuit to the plurality of connection points.

In further embodiments of the present invention, the cable distribution module also includes one or more internal video signal inputs. An internal signal amplifier circuit is electrically coupled to the internal video signal inputs. A second combiner circuit is coupled between the first combiner circuit and the splitter circuit and is electrically coupled between the internal signal amplifier circuit and the splitter circuit. The cable input may receive a cable television (CATV) signal in a first frequency band. Each of the internal video signal inputs may have an associated frequency band different from the first frequency band so that a receiver connected to one of the plurality of connection points may select between the CATV signal and the internal video signals as a received signal by tuning to an associated frequency band for one of the signals. A third combiner circuit may be provided to couple the plurality of internal video signal inputs to the internal signal amplifier circuit. The splitter circuit may include at least 32 connection points.

In other embodiments of the present invention, video distribution modules are provided for routing a video connection to a plurality of connection points. The modules include a video input configured to receive a video signal from either an antenna or a cable network. A two stage amplifier circuit is electrically coupled between the video input and the plurality of connection points. The two stage amplifier circuit includes a first stage amplifier having a high signal gain and a low noise figure and a second stage amplifier having a high output power and a low distortion. A splitter circuit is coupled between the two stage amplifier circuit and the plurality of connection points. In addition, one or more internal video signal inputs may be provided with an internal signal amplifier circuit electrically coupled to the internal video signal inputs. A combiner circuit may then be coupled between the two stage amplifier circuit and the splitter circuit and electrically coupled between the internal signal amplifier circuit and the splitter circuit.

### BRIEF DESCRIPTION OF THE DRAWINGS

FIG. 1 is a front elevational view of a conventional cable distribution panel illustrating various video/cable distribution modules therein;

FIG. 2 is a block diagram of a video amplifier circuit according to embodiments of the present invention;

FIGS. 3A is a circuit diagram of a video amplifier circuit according to embodiments of the present invention; and

FIG. 3B is a circuit diagram including additional components which may be included in a video/cable distribution module according to embodiments of the present invention in cooperation with the video amplifier circuit of FIG. 3A.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. In the drawings, layers, objects and regions may be exaggerated for clarity.

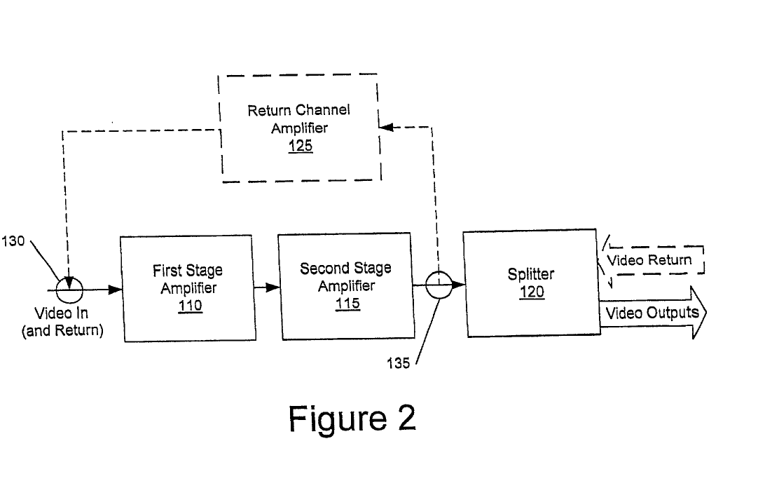

The present invention will now be described with reference to the embodiments illustrated in the figures. Referring first to FIG. 2, embodiments of video amplifier circuits according to the present invention will be further described. As shown in FIG. 2, a video input signal (VideoIn) is provided to an input of a first stage amplifier 110. The first stage amplifier 110 is selected to have a high signal gain and a low noise figure. Preferably, the signal gain of the first stage amplifier is greater than 15 decibels (dB) and the noise figure of the first stage amplifier 110 may be less than 3.5 dB and may further be less than 1.5 dB. The output of the first stage amplifier 110 is provided to an input of the second stage amplifier 115. The second stage amplifier 115 is a high output power, low distortion amplifier. Preferably, the output power of the second stage amplifier 115 is greater than 23 dBmV and the distortion of the second stage amplifier 115 is greater than about CSO 58 dBc and CTB 56 dBc. An output of the second stage amplifier 115 is coupled to an input of the splitter circuit 120. The splitter circuit 120 has a plurality of outputs.

By combining a high gain, low noise first stage amplifier with a high power, low distortion second stage amplifier, the present invention may provide for improved conditioning of an input video signal and, thereby, may support a greater number of distribution points than known two stage amplifiers without such a combination. In particular, amplifiers according to embodiments of the present invention may support a splitter circuit 120 which includes more than 16 outputs and, preferably, at least 32 outputs. Such capabilities may be supported in accordance with the present invention without incurring the greater expense typically associated with available high end, single stage high power amplifier circuits which would otherwise be needed to support this many outputs.

Also shown in dotted lines for the embodiments of FIG. 2 is optional return channel support circuitry. It is known that video signals, such as cable television (CATV or cable) signals are often used for bi-directional communications. To support such communications carried by a common cable, a return channel amplifier circuit 125 is shown in the embodiments of FIG. 2. A splitter (or diplexer) circuit 130 is provided to separate the forward and return channel circuitry at the video signal input point (VideoIn) and a combiner circuit 135 is shown recombining the signals at the input to the splitter circuit 120. Typically, a different frequency band is assigned to the forward and reverse channels. for example, a low frequency band may be provided for one direction and a higher frequency band for the opposite direction. Furthermore, a gap may be provided between the bands providing an offset between the two channel directions. For example, the return channel may be allocated to the band below 42 Megahertz (Mhz) while the forward channel may be allocated to a frequency band above 54 Mhz. An example of such bi-directional communications is provided by the digital over cable systems interface specification (DOCSIS) protocol.

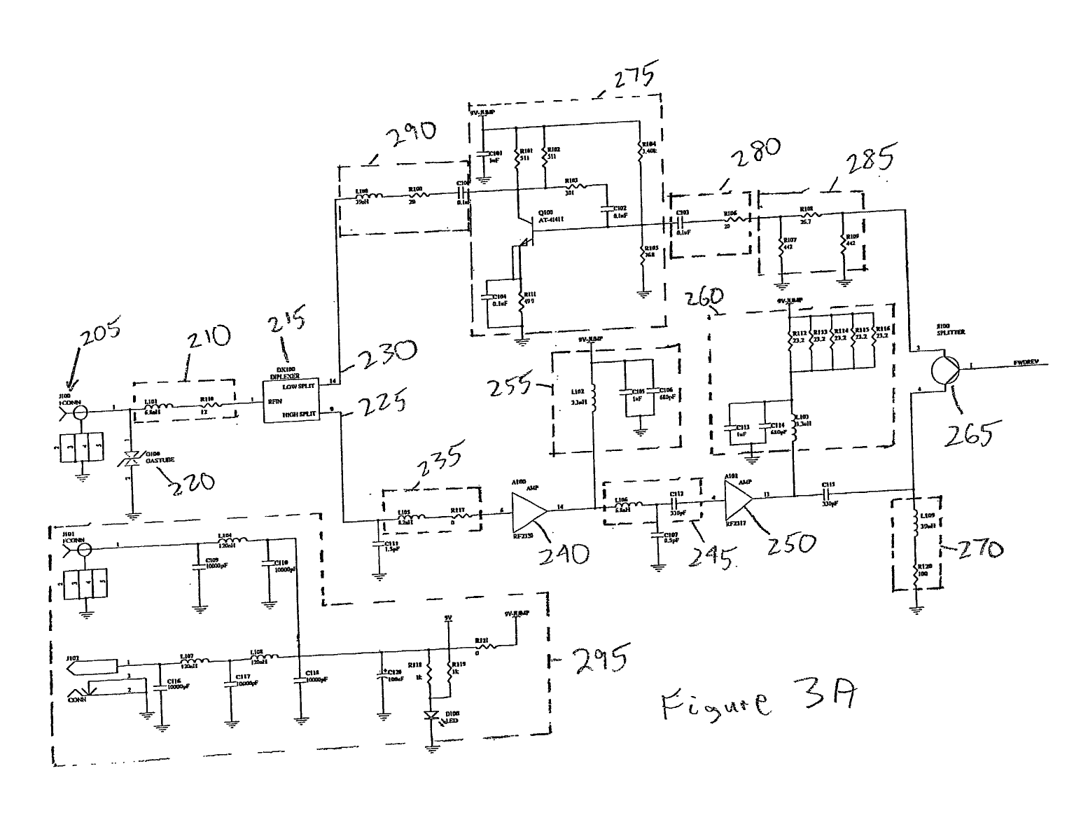

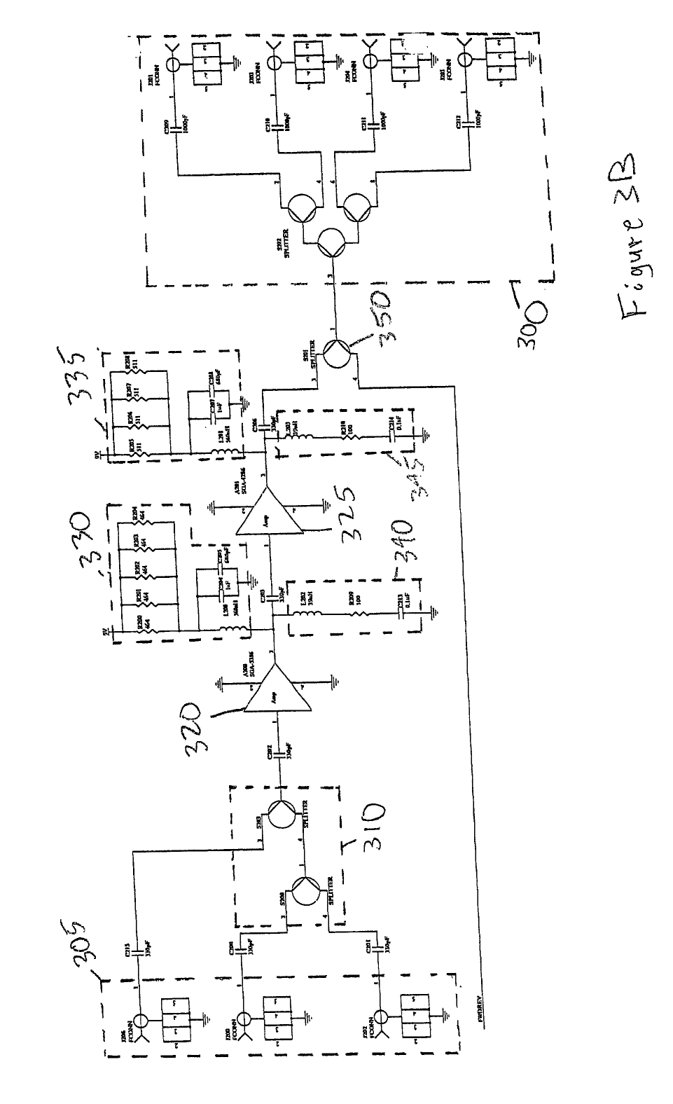

Embodiments of the present invention will now be further described with reference to the circuit diagram illustration of FIGS. 3A and 3B. FIG. 3A illustrates a bi-directional amplifier circuit according to embodiments of the present invention for processing a video signal connected to a splitter circuit 300 having a plurality of outputs. FIG. 3B illustrates additional internal video signal input circuitry connected to the splitter circuit 300 which may be utilized in a video/cable distribution module according to various embodiments of the present invention.

It is to be understood that, while specific components along with specific values for such components are illustrated in FIGS. 3A and 3B to aid in understanding the present invention, the invention is not limited to these specific combinations of components or component values. For example, a plurality of resistors of a first value connected in parallel could be replaced by a lesser number (including one) of resistors of different value(s). In addition, the illustrated components may be provided as discrete devices or integrated onto a custom integrated circuit device wherein the connection between illustrated components may be understood to be between “terminals” or “connections” or “inputs” or “outputs” of respective devices regardless of the specific fabrication technology used to provide the electrical coupling between respective devices. As used herein the terms “coupled” or “connected” refer to a connection which may include intervening devices or components while the terms “directly connected” or “directly coupled” refer to a connection without any intervening devices or components.

Referring first to FIG. 3A, a video input, such as an antenna or CATV (cable) input 205, receives the video input signal for amplification and splitting. A matching circuit 210 couples the video input 205 to a diplexer 215. As shown in FIG. 3A, the matching circuit 210 includes an inductor L101 (shown as 6.8 in nH) and a resistor R110 (shown as 12 (resistor value references are ohms herein)).

The diplexer 215 (shown as a DX100) has an input electrically coupled to the video input signal 205 and a high frequency output 225 and a low frequency connector 230. The high frequency output 225 couples to a high signal gain, low noise, first stage amplifier 240 (A100) (shown as an RF2320 available from RF Micro Devices, Inc. of Greensboro, N.C.) through a first matching circuit 235. The matching circuit 235 includes an inductor L105 (shown as 8.2 nH) and may include an optional resistor R117 (shown as 0 ohms).

The first stage amplifier 240 is electrically coupled to a high output power, low distortion second stage amplifier 250 (A101) (shown as an RF2317 available from RF Micro Devices, Inc.) through a second matching circuit 245. The second matching circuit 245 includes an inductor L106 (shown as 6.8 nF) and a capacitor C112 (shown as 330 pF) for DC blocking. The matching circuit 245 may further include a capacitor C107 (shown as 0.5 pF) and capacitor C111 (shown as 1.5 pF) which may be provided for noise control/filtering.

A first biasing circuit 255 is coupled to the output of the first stage amplifier 240 and a second biasing circuit 260 is electrically coupled to the output of the second stage amplifier 250. The fist biasing circuit 255 includes an inductor L102 (shown as 3.3 μH), a bypass capacitor C1O5 (shown as 1 μF) and a bypass capacitor C106 (shown as 680 pF). The second biasing circuit 260 includes an inductor L103 (shown as 3.3 μH), a bypass capacitor C113 (shown as 1 μF), a bypass capacitor C114 (shown as 680 pF) and resistors R112-R116 (shown as 23.2). In addition, a direct current (DC) blocking circuit is provided at the output of the second stage amplifier 250 by the capacitor C115 (shown as 330 pF).

The circuit illustrated in FIG. 3A includes circuitry for supporting a video input/output signal at the video input 205 for bidirectional communications by inclusion of a return channel circuit. The return channel circuit includes a return channel amplifier circuit 275 coupled between the low frequency connector 230 of the diplexer 215 and a combiner circuit 265 (S100). The combiner circuit 265 electrically couples both the return channel amplifier circuit 275 and the second stage amplifier 250 to the splitter circuit 300 shown in FIG. 3B.

In addition to the return channel amplifier circuit 275, the return channel further includes a first return channel matching circuit 280 coupling the return channel amplifier circuit 275 to the combiner circuit 265 and a second return channel matching circuit 290 that couples the return channel amplifier circuit 275 to the low frequency connector 230 of the diplexer 215. Finally, a 3 dB pad 285 is shown in the return channel circuit of FIG. 3A. The first return channel matching circuit 280 includes a capacitor C103 (shown as 0.1 μF) and a resistor R106 (shown as 20). The second return channel matching circuit 290 includes an inductor L100 (shown as 39 nH), a resistor R100 (shown as 20) and a capacitor C100 (shown as 0.1 μF). The 3 dB pad 285 includes resistors R107, R109 (shown as 442) and a resistor R108 (shown as 26.7). A power circuit 295 is also illustrated in FIG. 3A for providing electrical power to the amplifier circuitry described herein.

Further aspects of various embodiments of the present invention will now be described with reference to the circuit diagram of FIG. 3B. A plurality of internal video signal inputs 305 are shown in FIG. 3. While three inputs are shown in FIG. 3, it is to be understood that additional internal video signal inputs could be provided by connecting splitters, such as six-way or eight-way splitters, to each of the three inputs J200, J202, J206 shown for the plurality of internal video inputs 305. For example, the input J206 could be connected to a six-way splitter allowing up to six security camera signal inputs to be connected into the circuitry. In turn, the connector input J200 could be connected, for example, to a variety of DVD, VCR or other video signal sources within a residence using the video amplifier circuits of the present invention in a cable or video distribution module.

A combiner circuit 310 couples the plurality of internal video signal inputs 305 to an internal signal amplifier circuit which is shown in FIG. 3B as a two stage amplifier circuit including a first amplifier 320 and a second amplifier 325. The first amplifier 320 has a biasing circuit 330 coupled to its output and the second amplifier 325 has a biasing circuit 335 connected to its output. Similarly, the first amplifier 320 has a tilt circuit 340 connected to its output and the second amplifier 325 has a tilt circuit 345 connected to its output which tilt circuits may be used to compensate for frequency roll off in the combiners.

The first biasing circuit 330 includes resistors R200-R204 (shown as 464), an inductor L200 (shown as 560 nH), a capacitor C204 (shown as 1 μF) and a capacitor C205 (shown as 680 pF). The second biasing circuit 335 includes resistors R205-R208 (shown as 511), an inductor L201 (shown as 560 nH), a capacitor C207 (shown as 1 μF) and a capacitor C208 (shown as 680 pF).

The first tilt circuit 340 includes an inductor L202 (shown as 39 nH), a resistor R209 (shown as 100) and a DC blocking capacitor C213 (shown as 0.1 μF). The second tilt circuit 345 includes an inductor L203 (39 nH), a resistor R210 (shown as 100) and a capacitor C214 (shown as 0.1 μF).

The combiner circuit 350 combines the amplified video/cable input signal from the combiner 265 and the amplified internal video signal output from the second stage amplifier 325 and electrically couples the combined signal to the splitter circuit 300. The splitter circuit 300, as illustrated in FIG. 3B, shows a four-way splitter configuration. However, a 32-way splitter configuration may be provided by connecting each output J201, J203, J204, J205 to an eight-way splitter to provide a total of 32 outputs from the splitter circuit 300. Other combinations may also be provided in a similar manner.

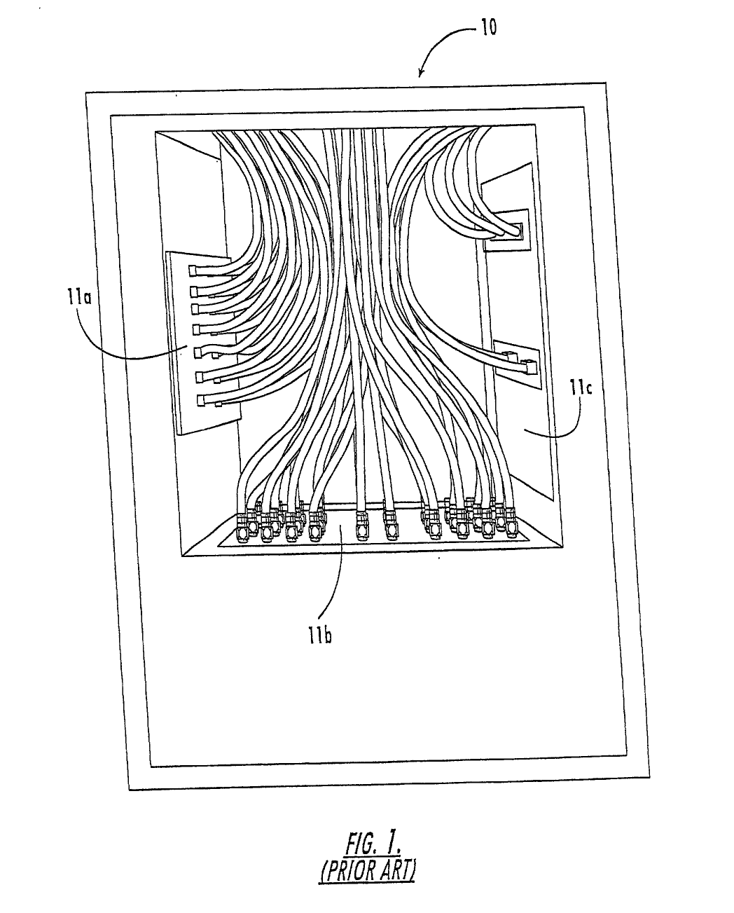

It will be understood that the block diagram and circuit diagram illustrations of FIGS. 1-3B and combinations of blocks in the block and circuit diagrams may be implemented using discrete and integrated electronic circuits. It will also be appreciated that blocks of the block diagram and circuit illustration of FIGS. 1-3B, and combinations of blocks in the block and circuit diagrams may be implemented using components other than those illustrated in FIGS. 13B, and that, in general, various blocks of the block and circuit diagrams and combinations of blocks in the block and circuit diagrams, may be implemented in special purpose hardware such as discrete analog and/or digital circuitry, combinations of integrated circuits or one or more application specific integrated circuits (ASICs).

Accordingly, blocks of the circuit and block diagrams of FIGS. 1-3B support electronic circuits and other means for performing the specified functions, as well as combinations of operations for performing the specified functions. It will be understood that the circuits and other means supported by each block and combinations of blocks can be implemented by special purpose hardware, software or firmware operating on special or general purpose data processors, or combinations thereof.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed:

1. A video amplifier circuit comprising:
a first stage amplifier having a high signal gain and a low noise figure and having an input coupled to a video input signal and an output;
a second stage amplifier having a high output power and a low distortion and having an input electrically coupled to the output of the first stage amplifier and an output; and
a splitter circuit having an input coupled to the output of the second stage amplifier and a plurality of outputs.

2. The video amplifier circuit of claim 1 wherein the output power of the second stage amplifier is greater than 23 decibels millivolts (dBmV) and wherein the distortion of the second stage amplifier is no greater than about CTB 56 dBc, CSO 58 dBc.

3. The video amplifier circuit of claim 2 wherein the signal gain of the first stage amplifier is greater than 15 decibels (dB) and the noise figure of the first stage amplifier is less than 3.5 dB.

4. The video amplifier circuit of claim 3 wherein the noise figure of the first stage amplifier is less than 1.5 dB.

5. The video amplifier circuit of claim 3 wherein the first stage amplifier is an RF2320 amplifier and the second stage amplifier is an RF2317 amplifier.

6. The video amplifier circuit of claim 1 wherein the splitter circuit includes more than 16 outputs.

7. The video amplifier circuit of claim 1 further comprising:
a first matching circuit coupling the video input to the input of the first stage amplifier;
a second matching circuit coupling the output of the first stage amplifier to the input of the second stage amplifier;
a first biasing circuit electrically coupled to the output of the first stage amplifier;
a second biasing circuit electrically coupled to the output of the second stage amplifier; and
a direct current (DC) blocking circuit coupling the output of the second stage amplifier to the input of the splitter circuit.

8. The video amplifier circuit of claim 1 wherein the video input signal comprises a video input/output signal for bi-directional communications and wherein the video amplifier circuit further comprises:
a diplexer circuit having an input electrically coupled to the video input/output signal and a high frequency output electrically coupled to the input of the first stage amplifier and a low frequency connector;
a return channel amplifier circuit electrically coupled between the low frequency connector of the diplexer and the input of the splitter circuit; and
a combiner circuit coupling the return channel amplifier and the second stage amplifier to the input of the splitter circuit.

9. The video amplifier circuit of claim 8 wherein the bi-directional communications comprises digital over cable systems interface specification (DOCSIS) protocol communications.

10. The video amplifier circuit of claim 8 further comprising:
a first return channel matching circuit coupling the return channel amplifier to the combiner circuit; and
a second return channel matching circuit coupling the return channel amplifier to the diplexer circuit.

11. A cable distribution module for routing a DOCSIS compatible connection with a cable network to a plurality of connection points, the module comprising:
a cable input configured to be connected to the cable network;
a diplexer circuit electrically coupled to the cable input that splits a signal on the cable input into a forward and a return channel;
a return channel amplifier circuit electrically coupled between the plurality of connection points and the diplexer circuit on the return channel;
a two stage amplifier circuit electrically coupled between the diplexer circuit and the plurality of connection points on the forward channel, the two stage amplifier circuit including a first stage amplifier having a high signal gain and a low noise figure and a second stage amplifier having a high output power and a low distortion;
a combiner circuit coupling the return channel amplifier circuit and the two stage amplifier circuit to the plurality of connection points; and
a splitter circuit coupling the combiner circuit to the plurality of connection points.

12. The cable distribution module of claim 11 wherein the output power of the second stage amplifier is greater than 23 decibels (dB) and wherein the distortion of the second stage amplifier is no greater than about CTB 56 dBc, CSO 58 dBc.

13. The cable distribution module of claim 12 wherein the signal gain of the first stage amplifier is greater than 15 decibels (dB) and the noise figure of the first stage amplifier is less than 3.5 dB.

14. The video amplifier circuit of claim 13 wherein the noise figure of the first stage amplifier is less than 1.5 dB.

15. The cable distribution module of claim 13 wherein the first stage amplifier is an RF2320 amplifier and the second stage amplifier is an RF2317 amplifier.

16. The cable distribution module of claim 15 further comprising:
at least one internal video signal input;
an internal signal amplifier circuit electrically coupled to the at least one internal video signal input; and
a second combiner circuit coupled between the first combiner circuit and the splitter circuit and electrically coupled between the internal signal amplifier circuit and the splitter circuit.

17. The cable distribution module of claim 16 wherein the cable input receives a cable television (CATV) signal in a first frequency band and wherein each of the at least one internal video signal inputs has an associated frequency band different from the first frequency band so that a receiver connected to one of the plurality of connection points may select one of the CATV signal or the at least one internal video signal as a received signal by tuning to an associated frequency band for one of the signals.

18. The cable distribution module of claim 16 wherein the at least one internal video signal input comprises a plurality of internal video signal inputs and wherein the module further comprises a third combiner circuit coupling the plurality of internal video signal inputs to the internal signal amplifier circuit.

19. The cable distribution module of claim 13 wherein the splitter circuit includes more than 16 connection points.

20. The cable distribution module of claim 19 wherein the splitter circuit includes at least 32 connection points.

21. A video distribution module for routing a video connection to a plurality of connection points, the module comprising:
a video input configured to receive a video signal from at least one of an antenna or a cable network;
a two stage amplifier circuit electrically coupled between the video input and the plurality of connection points, the two stage amplifier circuit including a first stage amplifier having a high signal gain and a low noise figure and a second stage amplifier having a high output power and a low distortion; and
a splitter circuit coupled between the two stage amplifier circuit and the plurality of connection points.

22. The video distribution module of claim 21 further comprising:
at least one internal video signal input;
an internal signal amplifier circuit electrically coupled to the at least one internal video signal input; and
a combiner circuit coupled between the two stage amplifier circuit and the splitter circuit and electrically coupled between the internal signal amplifier circuit and the splitter circuit.

23. The video cable distribution module of claim 22 wherein the output power of the second stage amplifier is greater than 23 decibels (dB) and wherein the distortion of the second stage amplifier is no greater than about CTB 56 dBc, CSO 58 dBc.

24. The video distribution module of claim 23 wherein the signal gain of the first stage amplifier is greater than 15 decibels (dB) and the noise figure of the first stage amplifier is less than 3.5 dB.

25. The video amplifier circuit of claim 24 wherein the noise figure of the first stage amplifier is less than 1.5 dB.

26. The video distribution module of claim 24 wherein the splitter circuit includes more than 16 connection points.

27. The video distribution module of claim 26 wherein the splitter circuit includes at least 32 connection points.
